(19) United States
(12) Patent Application Publication
(10) Pub. No.: US 2026/0138163 A1
(43) Pub. Date: May 21, 2026

(54) WALL MOUNTED ARTICULATED FUME EXTRACTION ARM

(71) Applicant: PAT TECHNOLOGY SYSTEMS INC., Vaudreuil-Dorion (CA)

(72) Inventors: Chau Thien VO, Roxboro (CA); Anthony KAZAZIAN, Pincourt (CA)

(21) Appl. No.: 19/352,896

(22) Filed: Oct. 8, 2025

Related U.S. Application Data
(60) Provisional application No. 63/705,191, filed on Oct. 9, 2024.

(51) Int. Cl. B08B 15/04; B23K 37/00

(52) U.S. Cl. CPC B08B 15/04; B23K 37/00

(57) ABSTRACT

A fume extraction system may include a base. An arm mechanism includes joints rotatably connecting members, one of the joints of the arm mechanism being a wrist joint. A flexible duct extends from an outlet end configured to be connected to a suction source, to an inlet end for suctioning fumes, the flexible duct operatively connected to the arm mechanism at the wrist joint. A translational joint is formed concurrently by the base and one of the joints of the arm mechanism, to allow translation of the one of the joints along the base. A guide configured to receive therein a portion of the flexible duct generally located in proximity to the outlet end to a location adjacent to the one of the joints.

### CROSS-REFERENCE TO RELATED APPLICATION

The present application claims the benefit of U.S. Patent Application No. 63/705,191, filed on Oct. 9, 2024, the entire contents of which are incorporated herein by reference.

### TECHNICAL FIELD

The application relates generally to fume extraction systems and, more particularly, to systems and methods used to evacuate fumes that may result from processes causing fume emissions as a by-product, such as welding operations, handheld laser cleaning (e.g., laser cleaning or laser removal of corrosion, paint, or other surface contaminants or coatings from surfaces such as wood, metal, etc), as examples among others.

### BACKGROUND

Fume emission is a concern for the safety of staff in different industries. Accordingly, different ventilation systems have been developed to perform fume extraction. For example, for processes involving welding, large overhead fume hoods or booths work well because their large effective fume extraction zones can accommodate longer weld lengths or spaced-out welds on parts. However, they are generally expensive given their size and large airflow requirements.

As an alternative to overhead fume hoods, an articulated fume extraction arm is a means to suspend a point source fume extraction nozzle in a workspace such that it may be positioned in proximity to a source of fumes, to allow the suction airflow from the nozzle to effectively capture the fumes. The articulated fume extraction arms typically have a series of links (i.e., tube segments), rotatably interconnected by joints, to form a conduit that is deformable. Such articulated fume extraction arm is typically wall mounted, or connected to an extraction apparatus that generates a vacuum flow, whether the extraction apparatus is mounted to a wall or self-standing. A maximum distance range between an anchor point of the arm on the wall or apparatus to the nozzle is determined by the length of the links, number of links and number of rotational joints that bind the links together. The operator of the articulated arm manually moves the nozzle by pushing and pulling the nozzle to the desired position and/or orientation. Given that the links are joined by rotational joints, the free end of the arm, where the nozzle is located, generally moves along an arc or several arc paths to cover a distance range. With enough rotational joints in the articulated arm, in different planes, a generally linear path of movement can be achieved for the nozzle. However, when covering a longer distance range, which requires either longer links, more links and/or more joints, the arm may block if the links pivot in an unintended direction. This requires the operator to let go of and move away from the nozzle, to reach and adjust the relative orientation of the links that have pivoted in unintended directions. Time and effort is wasted by the operator in positioning the arm in this manner.

Another type of suction duct is referred to as a rail-type suction duct. A rail type suction duct features sliding carriages that can extend the lateral range of an extraction arm. The rail-type suction duct is a duct that allows the suction airflow to be contained within a hollow conduit. The duct is made up of a metal C-channel which serves as a structural element that the arm carriage, on which the arm is attached, can ride on and translate laterally. The open side of the metal “C” channel is closed off, creating a tube, with strips of rubber that touch each other, so as to create a seal to close the C-channel. Thus, the device can then also be used as an air duct. The arm carriage is equipped with rollers that engage with the suction duct, to allow the arm carriage to move along the suction duct while supporting the extraction arm. The carriage also has a hollow appendage which is directed between the rubber seals, locally opening up the seal and allowing airflow to pass from the arm, through the hollow appendage, and into the suction duct. Due to the number of moving parts covered by seals, this system is prone to suction losses along the length of rubber seals. The appendage which locally splits the rubber seals also creates significant friction which then requires the operator to use significant physical effort to move the arm along the rail type suction duct.

### SUMMARY

In one aspect, there is provided a fume extraction system, comprising: a base; an arm mechanism including joints rotatably connecting members, one of the joints of the arm mechanism being a wrist joint; a flexible duct extending from an outlet end configured to be connected to a suction source, to an inlet end for suctioning fumes, the flexible duct operatively connected to the arm mechanism at the wrist joint; a translational joint formed concurrently by the base and one of the joints of the arm mechanism, to allow translation of the one of the joints along the base; and a guide configured to receive therein a portion of the flexible duct generally located in proximity to the outlet end to a location adjacent to the one of the joints.

Further in accordance with the aspect, for instance, the base includes at least one rail.

Still further in accordance with the aspect, for instance, the one of joints is a shoulder joint mounted to a carriage, the carriage mounted onto the at least one rail to form the translational joint.

Still further in accordance with the aspect, for instance, the guide and the rails are interconnected by a mount.

Still further in accordance with the aspect, for instance, the mount is a wall mount.

Still further in accordance with the aspect, for instance, the wall mount is a plate.

Still further in accordance with the aspect, for instance, the guide is a trough.

Still further in accordance with the aspect, for instance, an attachment is provided between the translational joint and the flexible duct.

Still further in accordance with the aspect, for instance, a gas extraction device may be operatively connected to the outlet end of the flexible duct.

Still further in accordance with the aspect, for instance, the members of the arm mechanism include an upper arm, a fore arm, and the joints of the arm mechanism include an elbow joint rotatably connecting the upper arm to the fore arm.

Still further in accordance with the aspect, for instance, the wrist joint is at an end of the fore arm.

Still further in accordance with the aspect, for instance, the joints of the arm mechanism include a shoulder joint connecting the upper arm to the translational joint.

Still further in accordance with the aspect, for instance, a rotational axis of the shoulder joint is upright.

Still further in accordance with the aspect, for instance, the upper arm forms a four-bar mechanism with the shoulder joint and the elbow joint.

Still further in accordance with the aspect, for instance, an upper arm biasing mechanism is operatively connected to the arm mechanism to maintain the upper arm in an equilibrium position in spite of gravity.

Still further in accordance with the aspect, for instance, a fore arm biasing mechanism is operatively connected to the arm mechanism to maintain the form arm in an equilibrium position in spite of gravity.

Still further in accordance with the aspect, for instance, the wrist joint is a spherical joint or a universal joint.

Still further in accordance with the aspect, for instance, a hood is at the inlet end of the flexible duct, the wrist joint connected to the hood.

Still further in accordance with the aspect, for instance, a handle is provided on the hood.

Still further in accordance with the aspect, for instance, the flexible duct as a helix structure.

The fume extraction device described above may include any of the following features, in any combinations.

The arm described herein may include any of the following features, in any combinations.

### DESCRIPTION OF THE DRAWINGS

Reference is now made to the accompanying figures in which:

FIG. 1 is a perspective view of a fume extraction system including an articulated fume extraction arm in accordance with an embodiment of the present disclosure, in an extended position; and

FIG. 2 is a perspective view of the articulated fume extraction arm of FIG. 1, in a contracted position.

### DETAILED DESCRIPTION

The present disclosure pertains to an articulated fume extraction arm mated to a source of air suction to evacuate fumes or other gases, such as fumes generated in a given process or action, such as during a welding operation as an example among others. The arm allows positioning of the fume extraction hood closer to the source of the fumes. This strategy may be less costly than overhead fume hoods because of the smaller size of the components of the articulated fume extraction arm and lower airflow requirements. The effective extraction zone is smaller than those of larger overhead fume hoods or fume booths and, therefore, the hood must be movable to be positioned in close proximity to the source of fumes. The fume extraction arm may be mounted on a wall, structure or directly mounted on top of an air suction device. The arm is described in greater detail below.

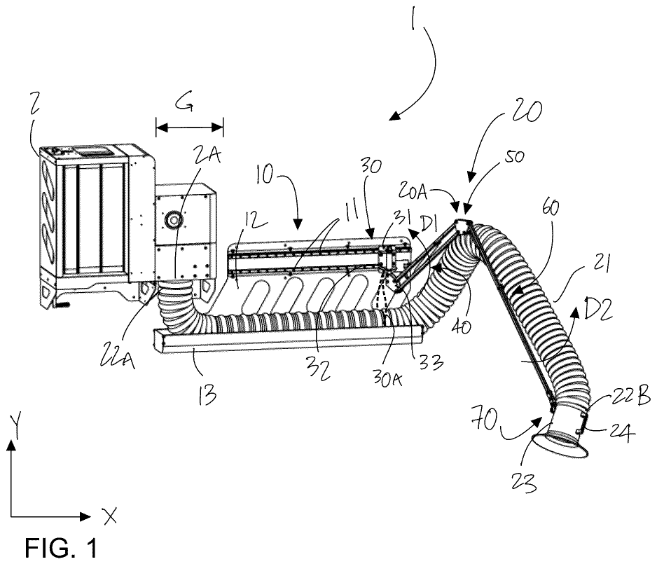

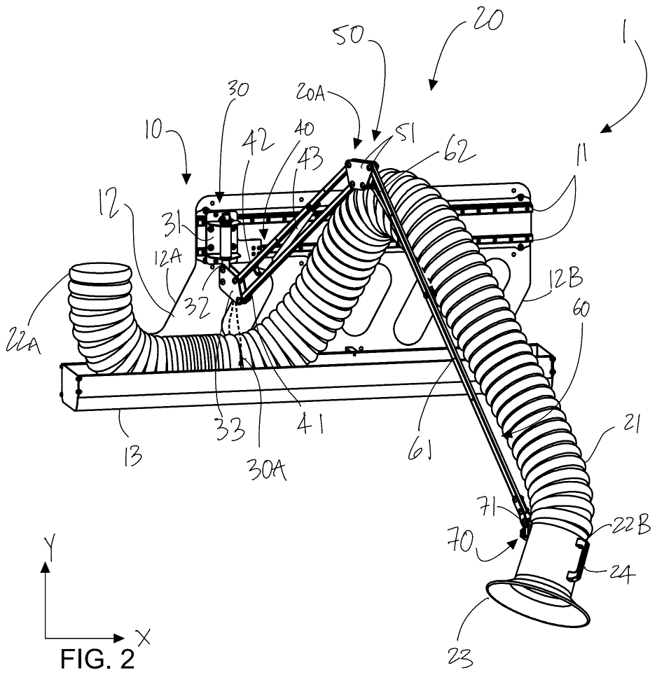

Referring to FIGS. 1 and 2, a fume extraction system is shown at 1. The fume extraction system 1 may include a gas extraction device 2 that generates a suctioning force to inhale (e.g., suck in) fumes generated during a given operation in which fumes are emitted. The gas extraction device 2 may include one or more filters to treat the fumes, and/or may be connected to a ventilation system to exhaust, capture and/or treat the fumes. In FIG. 1, the gas extraction device 2 is shown as being of the wall-mounted or structure-mounted type. The gas extraction device 2 may also be a portable apparatus (e.g., on wheels) or may be part of a facility, of a HVAC system, etc. In a variant, the system 1 is without the gas extraction device 2, as the gas extraction device 2 may be sold separately, or the system 1 may connect to a ventilation system, or other system of the facility.

The system 1 may include an articulated fume extraction arm assembly, simply “arm” below, shown at 20, supported operatively by a base 10. The base 10 may include a rail 11 or rails 11, or equivalent features enabling a translation of a component thereon, including a telescopic rod, a rod, etc. The expression rails 11 will be used herein as a function of the illustration found in FIGS. 1 and 2, even though equivalent features may be used.

The base 10 may further include a mount 12. In a variant, the rails 11 are mounted onto the mount 12, and the mount 12 is wall mounted. However, the rails 11 may be separated from the mount 12, i.e., no contact between them. The mount 12 is shown as being a plate, but can have other configurations, to be mounted to a wall, to a structure, or to be a part of the gas extraction device 2 or be connected to the gas extraction device 2. A guide 13 may also be present as part of the base 10. The guide 13 may be positioned below the rails 11 as illustrated in FIGS. 1 and 2. The guide 13 may be an open ended channel, such as a trough, with the opening of the guide 13 facing toward the rails 11. It could also be a plate, etc. Moreover, the rails 11 and the guide 13 may be parallel to one another, though this is optional. In a variant, when the base 10 is mounted to a wall, the rails 11 and/or the guide 13 may be generally parallel to the ground or horizon, as shown as axis X in the figures. Moreover, an end of the guide 13 may be offset along the X axis from an end of the rails 11, by gap G (FIG. 2), to define a space above the guide 13 and to the side of the rails 11 to position the gas extraction device 2, or a part thereof. This is merely optional.

As observed in FIGS. 1 and 2, the mount 12 spaces the rails 11 from the guide 13. Accordingly, by having a mount 12 between the rails 11 and the guide 13, installation of the base 10 to a structure, such as a wall, may be simplified, as the installation of the base 10 may occur as a whole. Alternatively, it is possible to have the rails 11 and the guide 13 as physically separated components, and thus installed one after the other. Stated differently, the mount 12 may be optional, as the rails 11 and guide 13 may be mounted to a structure, to a wall, etc. This may allow to have desired vertical spacing between the rails 11 and the guide 13. The rails 11, mount 12 and/or guide 13 may be screwed, nailed or attached in any appropriate manner to a wall, a structure, or may be mounted directly onto the gas extraction device 2.

Still referring to FIGS. 1 and 2, the arm or arm assembly 20 may include an arm mechanism 20A acting as a skeleton or support for a flexible duct 21 that is fluidly connected to the gas extraction device 2. The flexible duct 21 may be referred to as a hose, a tube, a pipe, etc. for simplicity, the flexible duct 21 may be referred to herein as duct 21. The duct 21 has an outlet end 22A fluidly connected to the gas extraction device 2 and an inlet end 22B via which the fumes are suctioned. For example, the duct 21 may be connected to a ventilation system, such as at the outlet end 22A. In a variant, the duct 21 is of the type that may include a rigid and deformable structure, such as a coil spring or like metallic material, with a sheath surrounding or captured with the rigid and deformable structure.

A hood 23 may be connected to the inlet end of the flexible duct 21. The hood 23 may have a frustoconical shape featuring a handle 24, to be manipulated by a user. Other shapes are contemplated. Moreover, the plain inlet end of the flexible duct 21 may be used without the hood 23. The distal edge of the hood 23 may be capable of lying in a plane so as to allow the hood 23 to come closer to a flat object or to the ground. Other shapes are possible. The hood 23 may extend the fume capture zone.

It can be observed that that flexible duct 21 has a portion thereof stowed into the guide 13. A suction port 2A of the gas extraction device 2 is spaced apart from the guide 13 along the Y axis to allow the flexible duct 21 to curve toward a horizontal trajectory in which the portion of the flexible duct 21 is in the guide 13, via a top open side thereof. Hence, it may be said that part of the flexible duct 21 is, to some extent, captive in the guide 13. However, as the guide 13 has cross-section dimensions allowing same to accommodate the flexible duct 21, the flexible duct 21 may expand and contract, as a response to forces applied thereon, as explained below.

In the depicted embodiment, the arm mechanism 20A may include a shoulder joint 30 engageable to the rail(s) 11, an upper arm 40 pivotably mounted to the shoulder joint 30, an elbow joint 50 pivotably mounted to the upper arm 40, a fore arm 60 pivotably mounted to the elbow joint 50, and a wrist joint 70 pivotably mounted to the fore arm 60. The wrist joint 70 supports the end of the duct 21 and/or the hood 23. These parts of the arm 20 are described one after the other below. The anatomical expressions “shoulder”, “arm”, “elbow” and “wrist” are used to illustrate a similarly with an anatomical arm, but these components may be referred to as joints 30, 50, 70 and links 40 and 60.

The shoulder joint 30 is operatively mounted to the rail(s) 11, via a carriage 31. Accordingly, a translational joint is formed, allowing the carriage 31 to translate relative to the rails 11. In FIGS. 1 and 2, the carriage 31 can move along axis X. Other arrangements are possible, so long as a translational joint (a.k.a., a sliding joint, a prismatic joint) is formed therebetween.

The shoulder joint 30 may further include a shaft 32 (a.k.a., pivot). The shaft 32 may be pivotably engaged to a housing of the carriage 31 for permitting rotation of the arm mechanism 20A around a longitudinal axis of the shaft 32. Hence, a revolute joint is formed, though other joints may be used as alternatives. In the illustrated embodiment, the shaft 32 may extend parallel to axis Y, but this is optional, and thus may optionally be upright. The shoulder joint 30 may include a plate(s) 33 secured to the shaft 32. In the illustrated embodiment, the shoulder joint 30 may include two parallel plates 33 spaced apart from each other to receive members of the upper arm 40. The one or more plates 33 define apertures to receive fasteners to secure the upper arm 40 to the shoulder joint 30, integral pins serving as pivots, etc.

The upper arm 40 includes a first member 41 and a second member 42 (or like links or linkages), which may be steel tubes, or any other suitable structural members (e.g., rods, square section rods, aluminum tubes, etc). The first member 41 and the second member 42 are substantially parallel to one another and are both pivotably engaged to the one or more plates 33 of the shoulder joint 30 at their proximal ends. Fasteners, such as bolts, nuts, and washers, may extend through apertures defined by the one or more plate 33 and through apertures defined at the proximal ends of the first member 41 and of the second member 42. In the context of the present disclosure, the expressions “proximal” and “distal” are in relation to a distance from the shoulder joint 30. In a variant, the first member 41 and the second member 42 are part of a four-bar mechanism, such as a four-bar parallelogram as shown, with the plate(s) 33 of the shoulder joint 30 and plate(s) 51 of the elbow joint 50. The four-bar parallelogram may be used to maintain an orientation of the elbow joint 50, such as relative to the ground. A single elongated member could be used as an alternative to the pair of members 41,42.

The arm mechanism 20A may optionally includes an upper arm biasing member 43 configured to exert a moment on the upper arm 40. The moment is exerted along direction D1 to rotate the upper arm 40 relative to the shoulder joint 30 in a counterclockwise direction in FIG. 1. The upper arm biasing member 43 is configured to oppose a weight of the arm 20 and of a free end the flexible duct 21. In the embodiment shown, the upper arm biasing member 43 may be a gas spring. The upper arm biasing member 43 has a proximal end pivotably engaged to the shoulder joint 30 at a location being offset from a longitudinal axis of the first member 41. In a variant, the proximal end of the upper arm biasing member 43 is mounted to the shoulder joint 30 coaxially with the proximal end 42A of the second member 42. This need not always be the case. The distal end of the upper arm biasing member 43 is pivotably mounted to the first member 41 between the proximal end and the distal end of the first member 41 of the upper arm 40. The distal end of the upper arm biasing member 43 may be mounted at any location along the first member 41 (or at elbow joint 50) as long as said location is offset from the proximal end of the first member 41.

In this configuration, the upper arm biasing member 43 exerts an expansion force to increase a distance between both of its ends. This exerts the moment in the direction D1 to assist rotation of the upper arm 40 along the direction D1. The upper arm biasing member 43 is able to generate a force selected to maintain the arm 20 substantially immobile when no external force is applied to it, against gravity.

In an alternate embodiment, the upper arm biasing member 43 may be configured to exert a retraction force (e.g., an elastic) to decrease the distance between both of its ends. In such a case, the proximal end of the upper arm biasing member 43 would be pivotably mounted to the shoulder joint 30 at a location being offset from a longitudinal axis of the second member 42, which is at a lower elevation than the first member 41 relative to a ground, and the distal end of the upper arm biasing member 43 would be pivotably mounted to the second member 42 at any location along the second member 42 as long as said location is offset from the proximal end 42A of the second member 42.

The elbow joint 50 may be located approximately midway along the length of the arm 20, but this is optional. The elbow joint 50 is configured to permit rotation of the upper arm 40 relative to the fore arm 60. In this embodiment, the elbow joint 50 includes two plates 51, but only one plate 51 may be used. The distal ends of the first member 41 and of the second member 42 are pivotably engaged to the plates 51. The plates 51 define apertures sized to receive fasteners 42, such as threaded bolts.

The plates 51 of the elbow joint 50 each define four apertures, namely, two upper arm apertures, a fore arm aperture, and a fourth aperture. The distal ends of the first and second members 41, 42 of the upper arm 40 are each in register with a respective one of the two upper arm apertures, as part of the four-bar mechanism.

Referring to FIGS. 1-2, the fore arm 60 is described in greater detail. The fore arm 60 includes a fore arm member 61 extending from a proximal end to a distal end. The proximal end is pivotably engaged to the elbow joint 50. The fore arm 60 further may optionally include a fore arm biasing member 62 having a proximal end pivotably mounted to the elbow joint 50 and a distal end pivotably mounted to the fore arm member 61. The proximal end of the fore arm member 61 is in register with the upper arm apertures of the plates 52 of the elbow joint 50. The proximal end of the fore arm biasing member is in register with the fourth apertures of the two plates 53. The proximal end of the fore arm biasing member 62 is offset from a longitudinal axis of the fore arm member 61.

Referring to FIGS. 1-2, as for the upper arm biasing member 43, the fore arm biasing member 62 may be a gas spring configured to exert an expansion force to increase a distance between its proximal and distal ends. The fore arm biasing member 62 is configured to exert a moment on the fore arm 60 along direction D2, which is counterclockwise in FIG. 1. Hence, the distal end of the fore arm biasing member 62 may be pivotably mounted to the fore arm member 61 at any locations along its length as long as it is offset from the proximal end of the fore arm member 61. In this case, the proximal end of the fore arm biasing member 62 is located at a lower elevation (i.e., closer to the ground) than the proximal end of the fore arm member 61. In an alternate embodiment, the fore arm biasing member 62 may be configured to exert a retraction force to bias its opposed ends towards each other. In such a case, the proximal end of the fore arm biasing member 62 would be located above the proximal end of the fore arm member 61.

Still referring to FIGS. 1 and 3, the wrist joint 70 is described in more detail. The wrist joint 70 may be pivotably mounted to a distal end of the fore arm member 61. The end of the duct 21 or the hood 23 is secured to a bracket 71 of the wrist joint 70. The orientation of the wrist joint 70 may also allow the hood's cylindrical section and the airflow to end up close to parallel to the ground as the hood is laid onto the ground which also optimizes airflow for an extended fume capture zone. The friction pad can also be placed on the flattened section. In a variant, the wrist joint 70 features a spherical joint (a.k.a., ball joint) or a universal joint to allow at least two rotational degrees of freedom between the fore arm member 61 and the hood 23.

The upper arm biasing member 43 helps to support the weight of an entirety of the arm 20. The force generated by the upper arm biasing member 43 is defined in such a way as to counteract the force of gravity to hold a desired static equilibrium position somewhere in the mid-range of the total range of motion of the upper arm 40. Each of the arm members 41, 42 of the upper arm 40 are attached to the elbow joint 50 in such a way to allow each arm member to pivot, though with optional constraint of a four-bar mechanism. The fore arm biasing member 62 is defined in such a way that it counteracts the force of gravity on the fore arm 60 to hold or to assist in holding a desired static equilibrium position somewhere in the mid-range of the total range of motion.

While a specific configuration of the arm mechanism 20A are detailed above, other configurations are possible. For example, it is possible not to use a four-bar mechanism. Moreover, more joints and more links may be present.

The system 1, and more particularly some of the components of the base 10, addresses some issues related to extending lateral distance range of a fume extraction arms. The arm 20 described herein is of typical design having the rotational shoulder joint 30 with a rotational axis that may be oriented to be perpendicular to the floor, the elbow joint 50 with an axis that may optionally be generally parallel to the floor and the wrist joint 70 which may be the ball joint, two closely located revolute joints or a single rotational joint in any axis, as options among others as detailed above. The configuration of the arm 20 ensures that the arm movement is intuitive and predictable to the operator. The presence of a flexible pipe 21 in the arm 20 eliminates the potential binding issues associated with rigid links interconnected by pivots beyond the typical design of an arm and eliminates the need to manually adjust the position of the link members by interacting with them directly. In addition, because of the single point of connection between the flexible pipe 21 and the gas extraction device 2 and limited movement therebetween as the outlet end 22A of the flexible pipe 21 hovers over the guide 13 and part of the flexible pipe 21 is held by the guide 13, potential losses of suction airflow are reduced, in contrast to rail-type suction duct and its longitudinal rubber seals. It also requires less force to move the arm 20 laterally due its alternative design which does not require the high-friction interaction between the longitudinal rubber seals and the hollow appendage.

Thus, the system 1 relies on a translation of the shoulder joint 30, for instance by way of a rail system 11, on the continuous compressible flexible duct 21, and on the guide 13 for the flexible duct 21, for the inlet end 22B of the flexible duct 21 to reach a target area, while a portion of the duct 21 remains stowed in the guide 13. As observed from FIG. 2, the duct 21 therefore generally conforms to the shape of the arm mechanism 20A. To facilitate installation, the rail system 11 may be affixed to the mount 12. The guide 13 (e.g., trough) may also affixed to the mount 12 for simplicity of installation. The mount 12 may serves to define a fixed vertical “Y” distance between the rails 11 and the bottom of the guide 13. The “Y” distance should be such that the shoulder joint 30 is at minimum the diameter of the flexible duct 21 and at maximum 1.5 times the diameter of the hose 21. The guide 13 may be parallel to the rails 11 along the horizontal “X” axis. The guide 13 may be offset from the plane of the mount 12 (if a wall plate) in the “Z” axis (i.e., projecting out of the plane of the figure sheets) at a distance such that that the rotational axis of the shoulder joint 30, at shaft 32, may lie in a plane featuring the X and Y axes, along with a longitudinal axis of the duct 21 when stowed in the guide 13. This is optional, but may contribute to keeping the portion of the duct 21 in the guide 13 from under the shoulder joint 30 toward the outlet 22A.

In an embodiment, the duct 21 may be a continuous compressible flexible duct having a helix structure supporting an airtight material. The helix structure may allow the duct 21 to maintain its shape, and may provide suitable compressibility to the duct 21. The duct 21 may have a compressibility of at least 30% of the maximum length of the duct 21, as an option. The helix is ideally external to the airtight material of the duct 21 to serve as a shield cage for the duct 21, against wear. Moreover, the helix may result in lower friction as the duct 21 slides against a surface of the guide 13, in comparison to some ducts having a rubbery outer surface. However, the flexible duct 21 may have an internal helix. The surface of the guide 13 may be coated with a slick, low friction material to limit friction and wear on the flexible duct 21. Whether the helix is internal or external to the airtight material of the duct 21, the helix creates corrugations on the outside of the flexible duct 21. The peaks of the corrugations become the contact points between the surface of the guide 13 and the flexible duct 21. Given that only the peaks are in contact with the surface of the guide 13, there is limited friction between the contact points. For example, there may be less friction than observed in rail-type suction ducts with sliding carriages. As the flexible duct 21 is continuous, there are limited or no losses of airflow through leakage as is observed with rail-type suction ducts with sliding carriages.

When the carriage 31 is at the initial contracted position on the rail(s) 11, such as in FIG. 2, the flexible duct 21 will be at its most compressed condition. When the arm carriage 31 is at its furthest point from the initial contracted position on the rail(s) 11, the flexible duct 21 will be at its maximum length. The flexible duct 21 may be attached to the shoulder joint 30, such as with a strap 30A, or other attachment or fastener (bracket, rod, etc), though this is optional. The use of such an attachment may also assist in preventing the duct 21 from falling out of the guide 13 when the shoulder joint 30 is pivoted in any direction. The attachment may also allow a force to be transmitted to the flexible duct 21 during translation of the carriage 31 along the rail(s) 11, when pulling or pushing the carriage 31, thus causing the flexible duct 21 to expand or contract accordingly. The attachment 30A and the relatively short distance between the shoulder joint 30 and bottom of the guide 13 work in conjunction to ensure that the application of a force on the flexible duct 21 along the longitudinal axis of the guide 13 is close enough to the central axis of the flexible duct 21 to assist in preventing the flexible duct 21 from kinking and falling out of the guide 13. The side walls of the guide 13 may be spaced apart a distance only slightly wider than a diameter of the flexible duct 21 such that the flexible duct 21 can easily slide along the length of the guide 13 without excessive friction, while the side walls of the guide 13 constrain the path of the flexible duct 21 within the guide 13, not allowing the flexible duct 21 to bend sideways. The depth of the guide 13 may be at least 50% of a diameter of the flexible duct 21 to provide sufficient constraint of the flexible duct 21, and keep the flexible duct 21 captive. However, this is optional as the value may be lower than 50%. A base wall of the guide 13 supports the flexible duct 21, not allowing it to sag or bend downward.

In a variant, a diameter of the duct 21 is selected as a function of a desired airflow. For example, an 8-inch diameter for the flexible duct 21 is ideally matched to an airflow of approximately 1000 cfm. The air resistance created by the corrugations and the inherent duct resistance in the duct 21 provides an additional force that assists the compression of the flexible duct 21 as the carriage 31 is moved toward the initial contracted position. The force may be sufficiently strong to cause the duct 21 to neatly and progressively compress as the arm carriage 31 is moved towards the initial contracted position, yet weak enough to allow the flexible duct 21 to expand when the arm carriage 31 is moved away from the initial contract position without significantly resisting the effort from the operator nor actually moving the arm carriage 31 from just the force imparted by the airflow within the flexible duct 21.

In a variant, it is possible to add rail(s) 11 and/or guide 13 end to end, to increase the stroke of movement of the carriage 31, while preserving the characteristics of operation of the system 1, i.e., a portion of the duct 21 remaining stowed into the guide 13. It may be required to move stoppers or end caps to allow the carriage 31 to move from one rail(s) 11 to another rail(s), the rails 11 being arranged end to end, and to form a continuous channel for end to end guides 13 (with overlap of one guide 13 into another). In a variant, the base 10 as described in FIGS. 1 and 2 is designed for end to end engagement, with side edges 12A and 12B being complementarily shaped for side-by-side abutment. Stated differently, the side edge 12B of a first base 10 abuts against the side edge 12A of a second base 10, with the guides 13 overlappingly engaged, and the rails 11 being end to end.

The fume extraction system may be generally described as including a base; an arm mechanism including joints rotatably connecting members, one of the joints of the arm mechanism being a wrist joint; a flexible duct extending from an outlet end configured to be connected to a suction source, to an inlet end for suctioning fumes, the flexible duct operatively connected to the arm mechanism at the wrist joint; a translational joint formed concurrently by the base and one of the joints of the arm mechanism, to allow translation of the one of the joints along the base; and a guide configured to receive therein a portion of the flexible duct generally located in proximity to the outlet end to a location adjacent to the one of the joints.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A fume extraction system, comprising:
a base;
an arm mechanism including joints rotatably connecting members, one of the joints of the arm mechanism being a wrist joint;
a flexible duct extending from an outlet end configured to be connected to a suction source, to an inlet end for suctioning fumes, the flexible duct operatively connected to the arm mechanism at the wrist joint;
a translational joint formed concurrently by the base and one of the joints of the arm mechanism, to allow translation of the one of the joints along the base; and
a guide configured to receive therein a portion of the flexible duct generally located in proximity to the outlet end to a location adjacent to the one of the joints.

2. The fume extraction system according to claim 1, wherein the base includes at least one rail.

3. The fume extraction system according to claim 2, wherein the one of joints is a shoulder joint mounted to a carriage, the carriage mounted onto the at least one rail to form the translational joint.

4. The fume extraction system according to claim 2, wherein the guide and the rails are interconnected by a mount.

5. The fume extraction system according to claim 4, wherein the mount is a wall mount.

6. The fume extraction system according to claim 4, wherein the wall mount is a plate.

7. The fume extraction system according to claim 1, wherein the guide is a trough.

8. The fume extraction system according to claim 1, wherein an attachment is provided between the translational joint and the flexible duct.

9. The fume extraction system according to claim 1, further including a gas extraction device operatively connected to the outlet end of the flexible duct.

10. The fume extraction system according to claim 1, wherein the members of the arm mechanism include an upper arm, a fore arm, and the joints of the arm mechanism include an elbow joint rotatably connecting the upper arm to the fore arm.

11. The fume extraction system according to claim 10, wherein the wrist joint is at an end of the fore arm.

12. The fume extraction system according to claim 10, wherein the joints of the arm mechanism include a shoulder joint connecting the upper arm to the translational joint.

13. The fume extraction system according to claim 12, wherein a rotational axis of the shoulder joint is upright.

14. The fume extraction system according to claim 12, wherein the upper arm forms a four-bar mechanism with the shoulder joint and the elbow joint.

15. The fume extraction system according to claim 12, wherein an upper arm biasing mechanism is operatively connected to the arm mechanism to maintain the upper arm in an equilibrium position in spite of gravity.

16. The fume extraction system according to claim 12, wherein a fore arm biasing mechanism is operatively connected to the arm mechanism to maintain the form arm in an equilibrium position in spite of gravity.

17. The fume extraction system according to claim 1, wherein the wrist joint is a spherical joint or a universal joint.

18. The fume extraction system according to claim 1, wherein a hood is at the inlet end of the flexible duct, the wrist joint connected to the hood.

19. The fume extraction system according to claim 18, wherein a handle is provided on the hood.

20. The fume extraction system according to claim 1, wherein the flexible duct as a helix structure.
